(19) United States
(12) Patent Application Publication
(10) Pub. No.: US 2023/0035258 A1
(43) Pub. Date: Feb. 2, 2023

(54) SOFT MAGNETIC METAL POWDER, DUST CORE, AND INDUCTOR

(71) Applicant: Murata Manufacturing Co., Ltd., Kyoto-fu (JP)

(72) Inventors: Masashi INOGUCHI, Nagaokakyo-shi (JP); Hiroshi NAGAKUBO, Nagaokakyo-shi (JP); Kenji SAKAGUCHI, Nagaokakyo-shi (JP)

(73) Assignee: Murata Manufacturing Co., Ltd., Kyoto-fu (JP)

(21) Appl. No.: 17/935,823

(22) Filed: Sep. 27, 2022

Related U.S. Application Data
(63) Continuation of application No. PCT/JP2021/013388, filed on Mar. 29, 2021.

(30) Foreign Application Priority Data
Mar. 31, 2020 (JP) 2020-064420

(51) Int. Cl. H01F 1/24; H01F 1/153

(52) U.S. Cl. CPC H01F 1/24; H01F 1/15308; H01F 1/15366; B82Y 30/00

(57) ABSTRACT

A soft magnetic metal powder includes a coated particle having a soft magnetic metal particle and a coating layer coating a surface of the soft magnetic metal particle. The coating layer contains at least one compound selected from the group consisting of molybdenum disulfide, molybdenum oxide, boron nitride, mica, talc, pyrophyllite, and kaolinite.

### CROSS-REFERENCE TO RELATED APPLICATIONS

This application claims benefit of priority to International Patent Application No. PCT/JP2021/013388, filed Mar. 29, 2021, and to Japanese Patent Application No. 2020-064420, filed Mar. 31, 2020, the entire contents of each are incorporated herein by reference.

### BACKGROUND

### Technical Field

The present disclosure relates to a soft magnetic metal powder, a dust core, and an inductor.

### Background Art

For an electronic component such as an inductor, a dust core manufactured by pressure-molding a soft magnetic metal powder is used. As the dust core, there has been proposed a dust core formed by pressure-molding a powder configured by a soft magnetic metal powder and an insulating film covering the powder.

For example, JP 4325950 B2 describes a soft magnetic material including: a plurality of composite magnetic particles having a metal magnetic particle and an insulating film surrounding a surface of the metal magnetic particle and containing at least one of a metallic salt phosphate and an oxide; and a lubricant formed as fine particles added at a proportion of 0.001 mass % or more and 0.01 mass % or less (i.e., from 0.001 mass % to 0.01 mass %) with respect to the plurality of composite magnetic particles, in which an average particle size of the lubricant formed as fine particles is 2.0 μm or less, and the lubricant formed as fine particles includes at least one of a metallic soap and an inorganic lubricant having a hexagonal crystal structure.

JP 6504289 B1 describes a soft magnetic metal powder including a plurality of soft magnetic metal particles containing Fe, in which a surface of the soft magnetic metal particle is covered with a covering portion, the covering portion includes a first covering portion and a second covering portion in this order from the surface of the soft magnetic metal particle toward the outside, the first covering portion contains one or more elements selected from the group consisting of Cu, W, Mo, and Cr, and the second covering portion contains P.

### SUMMARY

In the soft magnetic material described in JP 4325950 B2, the surface of the metal magnetic particle is surrounded by the insulating film containing at least one of a metallic salt phosphate and an oxide film, but since the metallic salt phosphate and the oxide film are inferior in flexibility, the soft magnetic material cannot follow the deformation of the metal magnetic particle during pressure molding and cracks, and the metal magnetic particles may be conducted with each other to increase a magnetic loss.

In the soft magnetic metal powder described in JP 6504289 B1, a metal such as Cu, W, Mo, or Cr is used as the first covering portion, and an oxide such as diphosphorus pentoxide is used as the second covering portion; however, the soft magnetic metal particles cannot be insulated from each other in the first covering portion formed from a metal, and the second covering portion containing P cracks during pressure molding, and there is a possibility that the soft magnetic metal particles are conducted with each other to increase a magnetic loss.

Accordingly, the present disclosure provides a soft magnetic metal powder capable of obtaining a dust core having a small magnetic loss. Also, the present disclosure provides a dust core having a small magnetic loss, and provides an inductor including the dust core.

A soft magnetic metal powder of the present disclosure includes a coated particle having a soft magnetic metal particle and a coating layer coating a surface of the soft magnetic metal particle, in which the coating layer contains at least one compound selected from the group consisting of molybdenum disulfide, molybdenum oxide, boron nitride, mica, talc, pyrophyllite, and kaolinite.

A dust core of the present disclosure has soft magnetic metal particles, and an interface layer present at an interface between the soft magnetic metal particles, in which the interface layer contains at least one compound selected from the group consisting of molybdenum disulfide, molybdenum oxide, boron nitride, mica, talc, pyrophyllite, and kaolinite, and a molding density is 85% or more.

An inductor of the present disclosure includes the above-described dust core.

According to the present disclosure, it is possible to provide a soft magnetic metal powder capable of obtaining a dust core having a small magnetic loss. According to the present disclosure, it is possible to provide a dust core having a small magnetic loss and an inductor including the dust core.

### BRIEF EXPLANATION OF DRAWINGS

FIG. 1 is a schematic sectional view illustrating an example of a coated particle constituting a soft magnetic metal powder of the present disclosure;

FIG. 2 is a schematic sectional view of a chamber of a coating device used for producing the soft magnetic metal powder of the present disclosure;

FIG. 3 is a schematic sectional view illustrating an example of an internal structure of a dust core of the present disclosure;

FIG. 4 is a perspective view schematically illustrating an example of an inductor of the present disclosure;

FIG. 5A is a bright-field image obtained by capturing a section of a coated particle constituting a soft magnetic metal powder obtained in Example 1 with a scanning transmission electron microscope, FIG. 5B is a mapping image of an Fe element, FIG. 5C is a mapping image of a Mo element, FIG. 5D is a mapping image of an S element, and FIG. 5E is a mapping image of an O element; and

FIG. 6 is a table showing SEM images, Fe mapping images, Mo mapping images, and Bi mapping images obtained by observing sections of dust cores obtained in Examples 6 to 10 and Comparative Example 2 with a scanning electron microscope.

### DETAILED DESCRIPTION

Hereinafter, a soft magnetic metal powder, a dust core, and an inductor of the present disclosure will be described.

However, the present disclosure is not limited to the following configuration, and can be appropriately modified and applied without changing the gist of the present disclosure. The present disclosure also includes a combination of two or more of each desirable configuration of the embodiments described below.

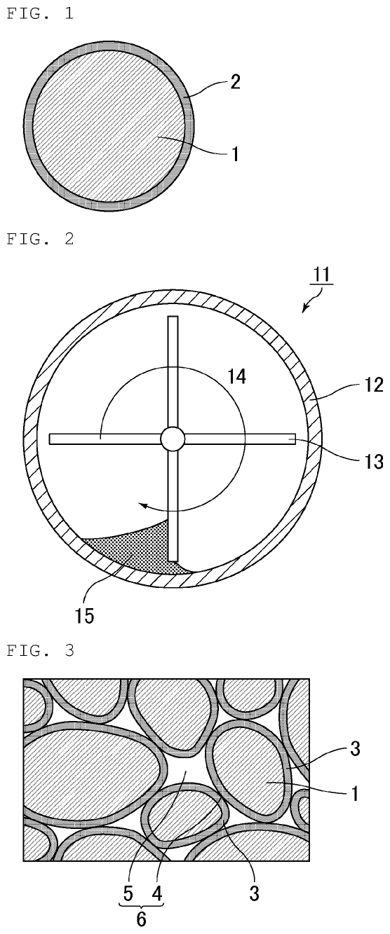

A soft magnetic metal powder of the present disclosure includes a coated particle having a soft magnetic metal particle and a coating layer coating a surface of the soft magnetic metal particle. FIG. 1 illustrates a schematic sectional view of an example of a coated particle constituting the soft magnetic metal powder of the present disclosure. As illustrated in FIG. 1, the coated particle includes a soft magnetic metal particle 1 and a coating layer 2 coating a surface thereof.

A soft magnetic metal constituting the soft magnetic metal particle is not particularly limited as long as it is a metal material showing soft magnetic properties, and may be a crystalline system or an amorphous system. For example, a metal material containing Fe as a main component is preferred, and specifically, a pure iron-based soft magnetic material (electromagnetic soft iron), an Fe-based alloy, an Fe—Si-based alloy, an Fe—Ni-based alloy, an Fe—Al-based alloy, an Fe—Si—Al-based alloy, an Fe—Si—Cr-based alloy, an Fe—Ni—Si—Co-based alloy, an Fe-based amorphous alloy, or an Fe-based nanocrystalline alloy is more preferred. Examples of the Fe-based amorphous alloy include Fe—Si—B-based and Fe—Si—B—Cr—C-based amorphous alloys. Examples of the Fe-based nanocrystalline alloy include Fe—B-based, Fe—Si—B—Cu-based, Fe—Si—B—Cu—Cr-based, Fe—Si—B—C—Cu-based, Fe—Si—B—P—C—Cu-based, Fe—Si—B—P—C—Cu—Sn-based, Fe—Si—B—Nb-based, Fe—Si—B—Nb—Cu-based nanocrystalline alloys. From the viewpoint of increasing the permeability, the soft magnetic metal is preferably an Fe-based amorphous alloy or an Fe-based nanocrystalline alloy, and is more preferably an Fe-based amorphous alloy. Metal glass is included in the Fe-based amorphous alloy. The metal glass has a composition in which a glass transition is clearly observed among amorphous alloys. The soft magnetic metal may be used singly or in combination of two or more kinds thereof.

The average particle size of the soft magnetic metal particle is preferably 1 μm or more and 30 μm or less (i.e., from 1 μm to 30 μm), more preferably 1 μm or more and 20 μm or less (i.e., from 1 μm to 20 μm), and further preferably 1 μm or more and 10 μm or less (i.e., from 1 μm to 10 μm). The average particle size can be measured by a laser diffraction/scattering type particle size/particle size distribution measuring apparatus. By setting the average particle size in the above range, both moldability and magnetic properties can be improved. Two or more kinds of soft magnetic metal powders having an average particle size within the above range and having different average particle sizes can also be appropriately mixed and used. By mixing powders having different average particle sizes, small particles enters voids of large particles, and moldability can be further improved.

The coating layer contains at least one compound (hereinafter, also described as “compound (1)”) selected from the group consisting of molybdenum disulfide, molybdenum oxide, boron nitride, mica, talc, pyrophyllite, and kaolinite. The coating layer may be a single layer including only one layer containing the compound (1), or may be a multilayer including two or more layers containing the compound (1). When the coating layer is a multilayer, the type of the compound (1) may be different for each layer, and for example, the coating layer may include a first layer containing molybdenum disulfide and a second layer containing boron nitride. When the coating layer is a multilayer, the number of layers of the coating layer is not particularly limited, but may be, for example, ten layers or less, or three layers or less. The coating layer may include a mixed layer containing two or more kinds of compounds (1), and for example, one layer containing the compound (1) may contain both of molybdenum disulfide and molybdenum oxide, or may contain three kinds of molybdenum disulfide, molybdenum oxide, and boron nitride.

The coating layer may contain impurities contained in each compound. In particular, when the compound is a mineral such as mica, talc, pyrophyllite, or kaolinite, the mineral may contain impurities.

Mica is a layered compound represented by X₂Y₄₋₆Z₈O₂₀(OH,F)₄ [wherein X is one or more selected from K, Na, Ca, Ba, Rb and Cs, Y is one or more selected from Al, Mg, Fe, Mn, Cr, Ti, and Li, and Z is one or more selected from Al, Fe, and Ti]. Talc is a layered compound represented by Mg₃Si₄O₁₀(OH)₂. Pyrophyllite is a layered compound represented by Al₂Si₄O₁₀(OH)₂. Kaolinite is a layered compound represented by Al₄Si₄O₁₀(OH)₈.

The compound (1) is at least one selected from the group consisting of molybdenum disulfide, molybdenum oxide, boron nitride, mica, talc, pyrophyllite, and kaolinite. Since the compound (1) is a layered compound, the compound (1) acts as a mold lubricant, promotes movement and rearrangement of particles during molding, and improves molding density. The elastic strain applied to the soft magnetic metal particle can be reduced and an increase in hysteresis loss can be suppressed by a layer containing a layered compound. Therefore, it is possible to form a dust core which has a high density, is excellent in frequency characteristics of permeability, can increase the resistance of the dust core, and has a small magnetic loss. The compound (1) is preferably a compound having a hexagonal layered crystal structure, more preferably at least one selected from the group consisting of molybdenum disulfide, molybdenum oxide, and boron nitride, and further preferably molybdenum disulfide, from the viewpoint of further enhancing the lubricity during molding so that a magnetic loss of a dust core to be obtained can be further reduced.

The coating layer may be a layer composed only of the compound (1) or a layer containing a substance other than the compound (1), but preferably contains the compound (1) in an amount of 50 mass % or more, more preferably 75 mass % or more, further preferably 90 mass % or more, still more preferably 95 mass % or more, especially preferably 99 mass % or more, and particularly preferably substantially composed only of the compound (1). Examples of the substance other than the compound (1) include polyimide and glass (preferably, glass having a softening point of 300° C. or higher and a glass crystallization point of 600° C. or lower).

The average thickness of the coating layer is not particularly limited, but the average thickness is preferably 1 nm or more and 200 nm or less (i.e., from 1 nm to 200 nm), from the viewpoint of enhancing lubricity during molding, and obtaining a dust core having excellent frequency characteristics of permeability and a small loss. The average thickness thereof is more preferably 5 nm or more and further preferably 10 nm or more, and is more preferably 100 nm or less, further preferably 50 nm or less, still more preferably 40 nm or less, and particularly preferably 30 nm or less.

The average thickness of the coating layer of the soft magnetic metal powder is determined by measuring the average particle size of the soft magnetic metal powder with a laser diffraction/scattering type particle size/particle size distribution measuring apparatus, then removing a coated particle having a particle size larger than the average particle size by 20% or more with a sieve, producing a sample for observing a section of the selected coated particle, observing sections of a plurality of coated particles having an apparent particle size of the average particle size measured above ±20% using a transmission electron microscope or a scanning electron microscope, measuring the thicknesses of coating layers, and averaging the thicknesses of the coating layers.

The coated particle may have the coating layer and the soft magnetic metal particle surface in direct contact with each other, may have a layer other than the coating layer inside the coating layer (on the soft magnetic metal particle side), or may have a layer other than the coating layer outside the coating layer (on the side opposite to the soft magnetic metal particle). The coated particle preferably has the coating layer as the outermost layer since lubricity during molding and the molding density of the resulting dust core can be increased.

It is preferable that the coated particle does not include a layer containing a phosphorus atom outside the soft magnetic metal particle. Specific forms in which the coated particle does not include a layer containing a phosphorus atom include (1) a form in which the coated particle includes only the soft magnetic metal particle and the coating layer containing no phosphorus atom, (2) a form in which the coated particle includes only the soft magnetic metal particle, the coating layer containing no phosphorus atom, and one or more layers different from the coating layer and containing no phosphorus atom (hereinafter, also referred to as a “phosphorus atom-free layer”), and the phosphorus atom-free layer is present inside the coating layer, (3) a form in which the coated particle includes only the soft magnetic metal particle, the coating layer containing no phosphorus atom, one or more layers of the phosphorus atom-free layers, and the phosphorus atom-free layer is present outside the coating layer, and (4) a form in which the coated particle includes only the soft magnetic metal particle, the coating layer containing no phosphorus atom, and one or more layers of the phosphorus atom-free layers, and the phosphorus atom-free layer is present both inside and outside the coating layer.

The average particle size of the coated particle is preferably 1 μm or more and 30 μm or less (i.e., from 1 μm to 30 μm), more preferably 1 μm or more and 20 μm or less (i.e., from 1 μm to 20 μm), and further preferably 1 μm or more and 10 μm or less (i.e., from 1 μm to 10 μm). The average particle size can be measured by a laser diffraction/scattering type particle size/particle size distribution measuring apparatus. By setting the average particle size in the above range, both moldability and magnetic properties can be improved.

In the soft magnetic metal powder of the present disclosure, the proportion of the soft magnetic metal particles is preferably 90 mass % or more since the permeability of the resulting dust core can be increased. The proportion is preferably 95 mass % or more and more preferably 97 mass % or more, and from the viewpoint of increasing the powder resistivity, the proportion is preferably 99.9 mass % or less and more preferably 99.5 mass % or less.

In the soft magnetic metal powder of the present disclosure, the proportion of the compound (1) is 0.1 mass % or more and more preferably 0.5 mass % or more, from the viewpoint of increasing the powder resistivity. From the viewpoint that the permeability of the resulting dust core can be increased, the proportion of the compound (1) is preferably 10 mass % or less, more preferably 5 mass % or less, and further preferably 3 mass % or less.

In the soft magnetic metal powder of the present disclosure, the coverage rate of the soft magnetic metal particle by the coating layer is preferably 95% or more, more preferably 98% or more, and further preferably 100%. The coverage rate can be calculated, for example, by (1) analyzing constituent elements on the powder surface by X-ray photoelectron spectroscopy (XPS) to calculate the ratio between the amount of the coating layer constituent element and the amount of the soft magnetic metal particle constituent element, (2) acquiring an element mapping image of the surface of the soft magnetic metal particle by energy dispersive X-ray analysis (EDX) or wavelength dispersive X-ray analysis (WDX) to calculate the ratio between the area where the coating layer constituent element is detected inside the contour of the soft magnetic metal particle and the area of the soft magnetic metal particle, and (3) embedding the soft magnetic metal particle in a resin and polishing the soft magnetic metal particle to a produce a sample for observing the particle section with a transmission electron microscope (TEM), and acquiring an EDX image of the particle section to calculate the ratio between the contour length of the coating layer constituent element and the contour length of the soft magnetic metal particle.

The soft magnetic metal powder of the present disclosure can be obtained by putting the soft magnetic metal particle and the compound (1) into a container and mixing them while applying mechanical impact energy, more preferably mixing them while applying impact, compression and shear energy. For example, the soft magnetic metal powder of the present disclosure can be obtained by applying energy of 6 MJ/kg or more by a mixing treatment.

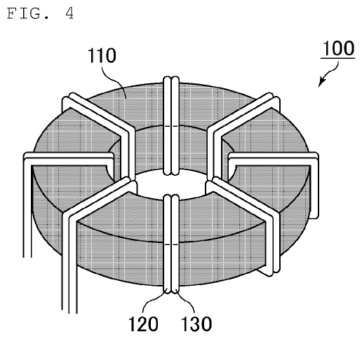

Examples of the coating device capable of mixing materials while applying mechanical impact energy as described above include a coating device 11 as illustrated in FIG. 2. The coating device 11 includes a chamber 12 having a cylindrical section, and is configured such that a blade 13 rotates in the chamber 12 as indicated by an arrow 14. A workpiece 15 (the soft magnetic metal particle and the compound (1)) is put into the chamber 12, and in this state, the blade 13 rotates at a rotation speed of, for example, 4000 to 6000 rpm, whereby the workpiece 15 is processed. Examples of the coating device as described above include a powder processing apparatus manufactured by HOSOKAWA MICRON CORPORATION. Examples of a device capable of mixing materials while applying a mechanical impact force include a planetary ball mill.

Since the soft magnetic metal powder of the present disclosure can increase the volume resistivity of the dust core and reduce the magnetic loss, the powder resistivity during pressurization at room temperature (about 25° C.) and 64 MPa is preferably 1.0×10³ Ω·cm or more. The powder resistivity is more preferably 1.0×10⁴ Ω·cm or more and further preferably 1.0×10⁵ Ω·cm or more. The soft magnetic metal powder of the present disclosure has the coating layer containing the compound (1), and thus can achieve the powder resistivity described above.

The soft magnetic metal powder of the present disclosure is suitably used as a material for the dust core.

A dust core of the present disclosure has soft magnetic metal particles, and an interface layer present at an interface between the soft magnetic metal particles, in which the interface layer contains at least one compound (1) selected from the group consisting of molybdenum disulfide, molybdenum oxide, boron nitride, mica, talc, pyrophyllite, and kaolinite, and a molding density is 85% or more. With the above configuration, the dust core of the present disclosure can maintain a high volume resistivity state, and the permeability hardly attenuates with respect to an increase in frequency. The loss when a magnetic field is applied is small. The dust core of the present disclosure can be obtained by powder compaction molding the soft magnetic metal powder of the present disclosure described above and performing a heat treatment as necessary. As the powder compaction condition, a conventionally known method can be employed. FIG. 3 is a schematic sectional view illustrating an example of an internal structure of the dust core of the present disclosure. As illustrated in FIG. 3, the dust core of the present disclosure has the soft magnetic metal particles 1 and an interface layer 3 present at an interface 4 between the soft magnetic metal particles 1.

The dust core of the present disclosure has a molding density of 85% or more. From the viewpoint that the permeability can be increased, the molding density is preferably 90% or more and more preferably 93% or more. By powder compaction molding the soft magnetic metal powder of the present disclosure described above, the molding density can be set in the above range. The higher the molding density is, the better it is, and the upper limit value is not limited, but for example, the upper limit value may be 100% or may be 99%. The molding density may be 89.40% or more and 96.60% or less (i.e., from 89.40% to 96.60%).

In the dust core of the present disclosure, by using the soft magnetic metal powder of the present disclosure as a material, the compound (1) coating the soft magnetic metal particle surface acts as a lubricant, and a high molding density can be realized. For example, without forming a coating layer of molybdenum disulfide or the like, it is possible to achieve only plastic deformation and high density by applying a high pressing force exceeding 1000 MPa in room temperature molding or hot molding. However, in such a case, a high volume resistivity cannot be realized. Since the layer containing the compound (1) can withstand a high temperature exceeding 400° C. and a pressing force of several hundred MPa, a high volume resistivity after hot molding can be maintained, and an increase in initial permeability and deterioration of frequency characteristics can be suppressed.

The average thickness of the interface layer is preferably 1 nm or more and 300 nm or less (i.e., from 1 nm to 300 nm). The average thickness thereof is more preferably 5 nm or more, further preferably 10 nm or more, and is more preferably 200 nm or less, further preferably 100 nm or less, still more preferably 50 nm or less, especially preferably 40 nm or less, and particularly preferably 30 nm or less. By setting the thickness in the above range, it is possible to obtain a dust core having high permeability and electric resistance and a small loss.

When two or more layers each containing at least one compound (1) selected from the group consisting of molybdenum disulfide, molybdenum oxide, boron nitride, mica, talc, pyrophyllite, and kaolinite are laminated, the average thickness of the interface layer is the sum of the two or more layers.

In the dust core of the present disclosure, the soft magnetic metal particle and the interface layer are preferably in direct contact with each other. At least parts of the soft magnetic metal particle and the interface layer may be in direct contact with each other, and there may be a portion where the soft magnetic metal particle and the interface layer are not in direct contact with each other.

In the dust core of the present disclosure, the coverage rate of the soft magnetic metal particle by the compound (1) is preferably 95% or more, more preferably 98% or more, and further preferably 100%. The coverage rate can be calculated by observing a section of the dust core using EDX analysis or WDX analysis, acquiring a mapping image of a soft magnetic metal particle constituent element or a coating layer constituent element, and calculating a ratio of the circumferential length of the coating layer and the circumferential length of the contour portion of the metal particle.

The dust core of the present disclosure preferably has a binding material at a grain boundary between the soft magnetic metal particles. By having the binding material at the grain boundary, the mechanical strength of the dust core is excellent. In the present specification, the “grain boundary between the soft magnetic metal particles” is a boundary between the soft magnetic metal particles adjacent to each other, and is a concept including an interface between the soft magnetic metal particles and a gap present between the soft magnetic metal particles. As illustrated in FIG. 3, the dust core has the soft magnetic metal particles 1 and the interface layer 3 present at the interface 4 between the soft magnetic metal particles 1, but a gap 5 is also present between the soft magnetic metal particles 1. The binding material may be present at the interface or may be present in the gap.

The binding material is not particularly limited, and is preferably glass, and examples thereof include various glass materials such as Si—B-based, Si—B-alkali metal-based, Si—B—Zn-based, V—Te-based, Sn—P—Zn-based, and liquid glasses.

The glass of the binding material is preferably glass containing at least one of bismuth, boron, vanadium, tin, and zinc. The contents of bismuth, boron, vanadium, tin, and zinc are not particularly limited, and glass containing known bismuth, boron, or the like used as a binding material can be used.

The content of the binding material is preferably 1 part by mass or more and 10 parts by mass or less (i.e., from 1 part by mass to 10 parts by mass), and more preferably 1 part by mass or more and 5 parts by mass or less (i.e., from 1 part by mass to 5 parts by mass), with respect to 100 parts by mass of the soft magnetic metal particles.

In the dust core of the present disclosure, the interface layer and the binding material are preferably in direct contact with each other. Such a form is a form which is formed when the soft magnetic metal powder of the present disclosure has no other layer outside the coating layer, that is, the coating layer is the outermost layer.

From the viewpoint that the dust core of the present disclosure can increase permeability and reduce the loss, the space factor of the soft magnetic metal particle is preferably 80% or more, more preferably 85% or more, and further preferably 90% or more. By powder compaction molding the soft magnetic metal powder of the present disclosure described above, the space factor of the soft magnetic metal particle can be set in the above range. The upper limit value of the space factor is not particularly limited, but the space factor may be 99% or less and may be 98% or less.

From the viewpoint that the magnetic loss can be further reduced, the volume resistivity of the dust core of the present disclosure is preferably 20 Ω·cm or more, more preferably 25 Ω·cm or more, further preferably 100 Ω·cm or more, and particularly preferably 500 Ω·cm or more. The volume resistivity is preferably high, and the upper limit value is not limited, but for example, the upper limit value may be 1×10⁵ Ω·cm. By powder compaction molding the soft magnetic metal powder of the present disclosure described above, the volume resistivity can be set in the above range.

In the dust core of the present disclosure, the initial permeability at 100 kHz is preferably 30 or more. The initial permeability is more preferably 40 or more and further preferably 50 or more. The upper limit of the initial permeability is not limited, but may be, for example, 1000 or less. By powder compaction molding the soft magnetic metal powder of the present disclosure described above, the initial permeability can be set in the above range.

In the dust core of the present disclosure, the initial permeability at 100 MHz is preferably 30 or more. The initial permeability is more preferably 40 or more and further preferably 50 or more. The upper limit of the initial permeability is not limited, but may be, for example, 1000 or less. By powder compaction molding the soft magnetic metal powder of the present disclosure described above, the initial permeability can be set in the above range.

In the dust core of the present disclosure, (initial permeability at 100 MHz/initial permeability at 100 kHz) is preferably 0.1 or more. The (initial permeability at 100 MHz/initial permeability at 100 kHz) is more preferably 0.5 or more and further preferably 0.8 or more. Within the above range, it can be said that the dust core is excellent in frequency characteristics.

In the dust core of the present disclosure, the loss when a magnetic field of 0.1 T and 50 kHz is applied is preferably 1000 kW/m³ or less. The loss is more preferably 500 kW/m³ or less, further preferably 400 kW/m³ or less, and particularly preferably 300 kW/m³ or less. The lower the loss is, the better it is, and the lower limit value is not limited, but for example, the lower limit value may be 1 W/m³ or may be 1 kW/m³.

The dust core of the present disclosure can be obtained by powder compaction molding the soft magnetic metal powder of the present disclosure described above and performing a heat treatment as necessary. The conditions for the powder compaction molding is not particularly limited, and may be appropriately determined depending on the soft magnetic metal particle and the type of the compound (1).

The dust core of the present disclosure can be used for an inductor, various coils, a reactor, a motor, a transformer, a DC-DC converter, an AC-DC converter, and the like.

An inductor of the present disclosure includes the dust core of the present disclosure described above. The inductor of the present disclosure preferably includes the dust core of the present disclosure and a winding disposed around the dust core.

The inductor of the present disclosure can have the same configuration as a conventionally known inductor except for including the dust core of the present disclosure, and can be manufactured by the same manufacturing method. The inductor of the present disclosure can be used for conventionally known applications.

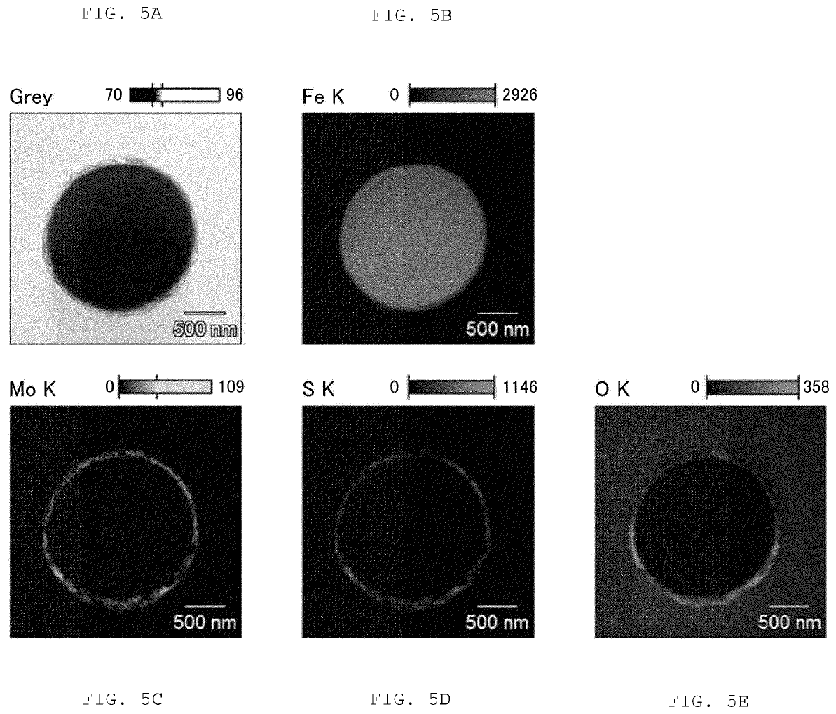

FIG. 4 is a perspective view schematically illustrating an example of the inductor. An inductor 100 illustrated in FIG. 4 includes a dust core 110 of the present disclosure, and a primary winding 120 and a secondary winding 130 wound around the dust core 110. In the inductor 100 illustrated in FIG. 4, the primary winding 120 and the secondary winding 130 are bifilar-wound around the dust core 110 having an annular toroidal shape.

The structure of the inductor is not limited to the structure of the inductor 100 illustrated in FIG. 4. For example, one winding may be wound around a dust core having an annular toroidal shape. The inductor may have a structure including the dust core of the present disclosure and a winding embedded in the dust core, or the like.

Since the space filling rate of the soft magnetic metal particle in the dust core is high, the inductor of the present disclosure is a coil having high permeability and a high saturation magnetic flux density.

### EXAMPLES

Hereinafter, examples more specifically disclosed for the soft magnetic metal powder, the dust core, and the inductor of the present disclosure will be described. The present disclosure is not limited to these examples.

In Examples and Comparative Examples, evaluation was performed as follows.

### [Average Thickness of Coating Layer of Soft Magnetic Metal Powder]

The average particle size is measured with a laser diffraction/scattering type particle size/particle size distribution measuring apparatus, and then a coated particle having a particle size larger than the average particle size by 20% or more is removed with a sieve. Next, a sample for observing a section of the selected coated particle is produced. For example, after embedding the powder in a resin, mechanical polishing, ion milling, a cross section polisher, a focused ion beam (FIB), or the like can be used. At this time, the particle size (apparent particle size) appearing in the sample for section observation is smaller than the particle size when the particle is shallowly scraped, and is close to the particle size when the particle is scraped so as to cross the vicinity of the center thereof. The observed thickness (apparent thickness) of the coating layer is thicker than the true thickness when the particle is shallowly scraped, and is close to the true thickness when the particle is scraped so as to cross the vicinity of the center thereof. Then, the average thickness is determined by observing sections of ten or more coated particles having an apparent particle size within the average particle size measured above ±20% using a scanning electron microscope or a transmission electron microscope, measuring the thicknesses of the coating layers, and averaging the thicknesses.

For example, when the average particle size of the coated particles is 5 μm, the coated particles are passed through a sieve through which particles having a particle size of 6 μm or less are passed, a sample for section observation is produced using the powder obtained through the sieve, and only particles having an apparent particle size of 4 μm or more and 6 μm or less (i.e., from 4 μm to 6 μm) may be measured. The apparent thickness of the coating layer observed in this manner falls within a range of +25% from the true thickness of the coating layer.

### [Calculation of Addition Amount of Coating Layer Material According to Target Thickness of Coating Layer of Soft Magnetic Metal Powder and Estimation of Thickness of Coating Layer]

A specific surface area SSA of the soft magnetic metal powder can be calculated using a specific weight ρ₁ and d₅₀ as:

SSA=6/(μ₁d₅₀).

When the specific weight of the coating layer material is designated as ρ₂ and the target thickness is was designated as t, an addition ratio w (mass %) of the coating layer material to be added is calculated as:

w=6tρ₂/ρ₁d₅₀×100.

On the other hand, in order to estimate a thickness t of a coating layer when a soft magnetic metal powder with a certain coating layer is obtained, the thickness t can be calculated as:

t=w/(ρ₂×SSA×100).

Herein, in the method for calculating w, ρ₂, and SSA of the obtained soft magnetic metal powder, first, only the coated soft magnetic metal particle having a large particle specific weight is extracted from the soft magnetic metal powder in order to remove the coating layer material not coating the soft magnetic metal particle. This can be extracted by exposing the soft magnetic metal powder to a magnetic field, centrifuging the soft magnetic metal powder after mixing the soft magnetic metal powder in a liquid, or separating the soft magnetic metal powder using a difference in specific weight by blowing air to the powder layer from below to create a flowing state. Next, composition analysis of each of the soft magnetic metal particle and the coating layer material is performed. For the composition analysis, inductively coupled plasma atomic emission spectroscopy (ICP-AES), inductively coupled plasma mass spectrometry (ICP-MS), fluorescent X-ray analysis (XRF), or the like can be used. When the coating layer is crystalline, the composition of the coating layer can also be determined by powder X-ray diffraction (XRD). From the composition analysis result, the specific weights ρ₁ and ρ₂ of the soft magnetic metal particle and the coating layer material, respectively, and the addition ratio w of the coating layer material are calculated. On the other hand, an average particle size d₅₀ is measured with a laser diffraction/scattering type particle size/particle size distribution measuring apparatus, and the specific surface area SSA of the soft magnetic metal powder can be calculated from the values of d₅₀ and ρ₁.

### [Average Thickness of Interface Layer of Dust Core]

A sample for section observation of the dust core is produced by the following method. Fragments obtained by cutting, breaking, or crushing the dust core are embedded in a resin and mechanically polished to produce the sample for section observation. Alternatively, sectional portions of fragments are polished by a method such as ion milling, a cross section polisher, or focused ion beam (FIB) to produce the sample for section observation. The produced sample for section observation is observed using a scanning electron microscope or a transmission electron microscope. In the case of using a scanning electron microscope, the soft magnetic metal particle portion and the interface layer portion can be distinguished by obtaining a backscattered electron image. The soft magnetic metal particle portion and the interface layer portion can also be distinguished by mapping the distribution of the soft magnetic metal particle constituent element (for example, Fe) and the interface layer constituent element (for example, Mo) using WDX analysis. In the case of using a transmission electron microscope, the soft magnetic metal particle portion and the interface layer portion can also be distinguished by mapping the distribution of the soft magnetic metal particle constituent element and the interface layer constituent element using EDX analysis. The soft magnetic metal particle portion and the interface layer portion can also be distinguished by observing a lattice image at the time of high magnification observation using the crystal structure (crystalline or amorphous, whether the crystal structure in the case of crystal is different) of the soft magnetic metal particle and the coating layer at the interface. For example, when the soft magnetic metal particle is amorphous and the coating layer is crystalline, the thickness of the interface is obtained as the thickness of the region where the lattice fringe is observed. The average thickness of the interface layer can be calculated by measuring the thickness of the portion where the interface layer is distributed at a plurality of points, for example, ten points by these methods and calculating the average. Herein, ten measurement points of the interface are selected in order from a point where the distance between the soft magnetic metal particles is short in the image obtained by observation.

[Powder resistivity during pressurization at room temperature (about 25° C.) and 64 MPa (measurement upper limit: 10 MΩcm)]

The powder resistivity was measured as the volume resistivity during pressurization at 64 MPa using powder resistivity measurement unit MCP-PD51 manufactured by Mitsubishi Chemical Analytech Co., Ltd.

### [Element Composition of Powder Surface]

The element composition was determined by X-ray photoelectron spectroscopy (XPS) analysis using PHI-5000 VersaProbe manufactured by ULVAC-PHI, Inc.

### [Molding Density of Dust Core]

An outer shape ϕo and an inner diameter ϕi of the dust core were measured at three points with a caliper to calculate an average value. The thickness t of the magnetic core was measured at four points using a micrometer to calculate an average value, and a volume Vc of the dust core was determined using the following formula.

$${V}_{c} = ( \frac{{∅}_{o}^{2} - {∅}_{i}^{2}}{4} ) \cdot π \cdot t \qquad [ Mathematical Formula 1 ]$$

A weight m of the sample was measured with an electronic balance, the weight ratio and weight of each component were calculated from the mixing ratio of the soft magnetic metal powder, a coating material (such as molybdenum disulfide), and the binding material, and a porosity n was determined by the following formula using the density of each component.

$$n = \{ {V}_{c} - ( \frac{{m}_{1}}{{ρ}_{1}} + \frac{{m}_{2}}{{ρ}_{2}} + \frac{{m}_{3}}{{ρ}_{3}} ) \} / {V}_{c} \qquad [ Mathematical Formula 2 ]$$

m₁ is the weight of the soft magnetic metal powder, m₂ is the weight of the coating material, m₃ is the weight of the binding material, ρ₁ is the density of the soft magnetic metal powder, ρ₂ is the density of the coating material, and ρ₃ is the density of the binding material. The molding density was calculated as 100−n (porosity).

### [Space Factor of Soft Magnetic Metal Particle in Dust Core]

The space factor was determined as {(m₁/ρ₁)}/V_{c} using V_{c}, m₁, and ρ₁ used for calculating the molding density.

### [Volume Resistivity of Dust Core]

An indium gallium (InGa) alloy was applied to the upper and lower surfaces of the dust core to form electrode surfaces. The dust core was sandwiched between two Kelvin clips and connected to a digital multimeter. The digital multimeter is not particularly limited as long as it can measure the resistance by a four-terminal method, and a constant voltage power supply and a resistance meter may be used in combination other than the digital multimeter. A volume resistivity p is calculated as the following formula:

ρ=R×(S/t)

using a resistance value R obtained by measurement and an electrode area S calculated from the following formula:

$$S = ( \frac{{∅}_{o}^{2} - {∅}_{i}^{2}}{4} ) \cdot π \qquad [ Mathematical Formula 3 ]$$

wherein ϕₒ is an outer diameter of the dust core and ϕᵢ is inner diameter of the dust core, and the thickness t of the dust core.

[Initial Permeability at 100 kHz and 100 MHz and Loss when Magnetic Field of 0.1 T and 50 kHz is Applied]

The initial permeability of the dust core was measured with an impedance analyzer E4991A and a magnetic material test fixture 16454A manufactured by Keysight Technologies.

The magnetic field loss of each of the dust cores obtained in Examples and Comparative Examples were measured using a BH analyzer SY8218 manufactured by IWATSU ELECTRIC CO., LTD. The diameter of a copper wire wound around the dust core was set to 0.26 mm. The number of turns of the primary winding for excitation and the number of turns of the secondary winding for detection were the same as 30 turns, and bifilar winding was performed.

### Example 1

A soft magnetic metal powder (AW2-PF.8F manufactured by EPSON ATMIX Corporation, average particle size: 5 μm, specific weight: 7.1 g/cm³) and a molybdenum disulfide (MoS²) powder (manufactured by DAIZO CORPORATION, average particle size: 0.45 μm, specific weight: 5.08 g/cm³) were prepared and weighed at a mass ratio (MoS₂ addition amount: 2.0 wt. %) at which the target thickness of the MoS₂ film was 25 nm based on the specific weight and the average particle size of each powder. Into a powder processing apparatus (NOBILTA MINI (NOB-MINI) manufactured by HOSOKAWA MICRON CORPORATION), 70 g of the weighed powder was introduced, and the soft magnetic metal powder was subjected to a coating treatment with MoS₂ at 6000 revolutions/min for 30 minutes to obtain a soft magnetic metal powder subjected to the coating treatment. Under the above conditions, the total amount of energy applied to the powder was about 8 MJ/kg.

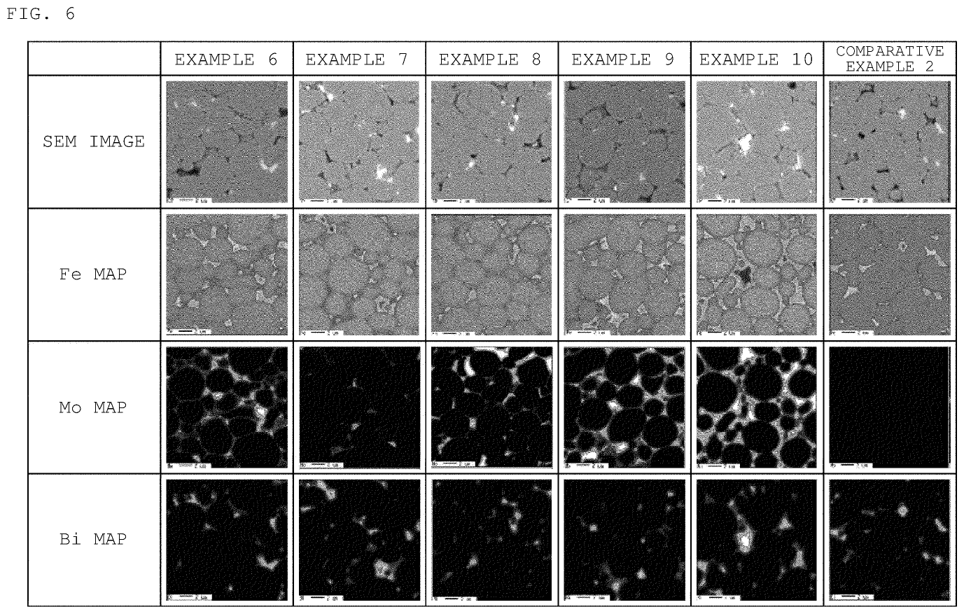

The powder resistivity of the soft magnetic metal powder subjected to the coating treatment was measured when a pressing force of 64 MPa was applied at room temperature. Results are shown in Table 1. The powder resistivity during pressurization when MoS₂ was coated with a target thickness of 25 nm was 445 kΩcm. Results of semi-quantitative analysis of element species and amounts on the particle surface of the same powder by X-ray photoelectron spectroscopy (XPS) analysis are shown in Table 2. In the XPS analysis result, C and O are contributions from CO₂ in the atmosphere suctioned on the particle surface. The amount of Fe was equal to or less than the lower detection limit, and it was confirmed that only Mo, S, and a part of O were distributed in a range of a depth of several nm from the powder particle surface in reality. That is, the soft magnetic metal particle surface is coated with Mo sulfide having a MoS₂ structure and Mo oxide having a MoO₃ structure, and the coverage rate is 100% or as close as possible to 100%. FIGS. 5A-5E show a bright-field image of a section obtained by embedding the same powder in a resin and polishing the section, then performing focused ion beam (FIB) processing, and using a scanning transmission electron microscope (STEM), and a mapping image of constituent elements measured by energy dispersive X-ray analysis (EDX). As can be seen from FIGS. 5A-5E, the surface of the soft magnetic metal particle is uniformly covered with a compound film including Mo sulfide having a MoS₂ structure and Mo oxide having a MoO₃ structure. The average thickness of the coating layer of the soft magnetic metal powder subjected to the coating treatment was measured and found to be 28 nm.

As described above, the powder resistivity of the soft magnetic metal powder subjected to the coating treatment during pressurization was 445 kΩcm, which was high resistance that could not be achieved by the soft magnetic metal powder not subjected to the coating treatment. This is considered to be caused because, as shown in the STEM-EDX image in FIGS. 5A-5E and the XPS analysis in Table 2, the soft magnetic metal particle surface is coated uniformly with a thin MoS₂ film to suppress conduction between the soft magnetic metal particles. The reason why a high resistance can be maintained when a pressure is applied is that MoS₂ has a strong covalent bond in a-axis and b-axis directions of the crystal lattice and has a weak van der Waals bond in a c-axis direction, and thus when MoS₂ is externally pressurized or rubbed, MoS₂ slides at a portion having the van der Waals bond without the entire film being broken (called interlayer slippage), so that a film remains without cracking the entire film in the thickness direction.

### Examples 2 to 5

MoS₂ was mixed with the soft magnetic metal powder in an amount to have a target thickness shown in Table 1 and treated by the same method as in Example 1 (in the case of target thicknesses of 6, 13, 50, and 100 nm, the addition amounts of MoS₂ are 0.5 wt. %, 1.0 wt. %, 4.0 wt. %, and 8.0 wt. %, respectively). The powder resistivity during pressurization at 64 MPa was measured using the soft magnetic metal powder subjected to the coating treatment. Results are shown in Table 1.

The average thickness of the coating layer of each soft magnetic metal powder subjected to the coating treatment in Examples 2, 3, 4, and 5 was measured, and the average thicknesses were 8.8 nm, 10.4 nm, 36.2 nm, and 66.5 nm, respectively.

### Comparative Example 1

A soft magnetic metal powder (AW2-PF.8F manufactured by EPSON ATMIX Corporation, average particle size: 5 μm) not subjected to the coating treatment with a MoS₂ powder was used as it was, and the powder resistivity during pressurization at 64 MPa was measured. Results are shown in Table 1.

From the comparison of the powder resistivity shown in Table 1, it was found that the powder resistivity of the soft magnetic metal powder can be significantly improved when MoS₂ is mixed and treated in such an amount that a film of only 6 nm is formed.

TABLE 1

| | Target | Addition | |
|---|---|---|---|
| | thickness of | amount of | Powder resistivity |
| | MoS₂ film | MoS₂ | during pressurization |
| | (nm) | (wt %) | at 64 MPa (Ωcm) |
| Example 1 | 25 | 2.0 | 4.45E+05 |
| Example 2 | 6 | 0.5 | 1.98E+06 |
| Example 3 | 13 | 1.0 | 1.36E+06 |
| Example 4 | 50 | 4.0 | 4.17E+05 |
| Example 5 | 100 | 8.0 | 3.97E+05 |
| Comparative | 0 | 0.0 | 3.90E+00 |
| Example 1 | | | |

TABLE 2

| | C | O | S | Fe | Mo |
|---|---|---|---|---|---|
| Surface element | 30.4 | 24.3 | 27.3 | Detection | 18.1 |
| composition | | | | lower limit or | |
| (atomic %) | | | | less | |

### Example 6

A glass powder (ASF1096 (glass containing Bi and B) manufactured by AGC Inc.) as a binding material in hot molding was weighed with respect to the soft magnetic metal powder subjected to the coating treatment produced in Example 1 so that the weight ratio of the soft magnetic metal powder subjected to the coating treatment:the binding material would be 98:2, and further kneaded and granulated simultaneously with an acrylic binder and toluene. The granulated powder thus obtained was introduced into a cemented carbide mold, placed in a pressure firing furnace, and heated at 445° C. in a Na atmosphere while applying a pressing force of 650 MPa to form a ring-shaped dust core. The temperature increasing rate and the retention time were set to 25° C./min and 2 minutes and 30 seconds, respectively. The temperature was lowered by natural cooling, and the depressurization was performed 1 minute after the temperature was lowered. In this hot molding, since the acrylic binder volatilizes, the acrylic binder does not act on binding of the magnetic core. In order to remove strain applied during molding, the dust core was placed in a box-type electric furnace, and subjected to a heat treatment at 435° C. for 1 hour in the air atmosphere. The copper wire was wound around the dust core to form an inductor.

The target thickness of the MoS₂ film, the molding density (100−porosity) of the dust core, the space factor of the soft magnetic metal particle, the volume resistivity, the initial permeability of the dust core at 100 kHz and 100 MHz, and the loss when a magnetic field of 0.1 T and 50 kHz is applied are shown in Table 3. The molding density of the dust core was as high as 94.60%, and the space factor of the soft magnetic metal particle also exceeded 90%. The volume resistivity was 975 Ω·cm, and it was confirmed that a high state can be maintained. The initial permeability at 100 kHz and the initial permeability at 100 MHz were 62 and 60, respectively, and hardly attenuated with respect to an increase in frequency. The loss when a magnetic field of 0.1 T and 50 kHz was applied was as small as 144.3 kW/m³. A sectional scanning electron microscope (SEM) image and an element mapping image by wavelength dispersive X-ray analysis (WDX) of the dust core are shown in FIG. 6. The average thickness of the interface layer in the dust core was 83 nm. This average thickness is larger than the average thickness of 28 nm of the coating layer of the soft magnetic metal particle having the coating layer formed, which is a material, but the coating layers of two particles adjacent to each other are combined, and the coating looks thick since the center of the metal particle is not polished to appear.

The reason why the molding density is high is that plastic deformation of the soft magnetic metal powder is promoted by molding in which heating and pressurization are simultaneously performed, and the soft magnetic metal powder surface is coated with a layered compound (molybdenum disulfide) to act as an internal lubricant. As shown in FIG. 6, since the layer of molybdenum disulfide is distributed without gaps at the grain boundary between the soft magnetic metal powders, the metal particles are not conducted to each other. Therefore, an increase in initial permeability and deterioration of frequency characteristics can be suppressed, and a low loss of 144.3 kW/m³ can be achieved.

Bi of the glass component is not distributed at the grain boundaries between the metal particles in a film shape, but is distributed in a gap portion without metal particles. That is, in this example, it is found that only MoS₂ coats the metal particle in a film shape.

In the above example, although the dust core is manufactured by hot molding, and then a copper wire is wound around the dust core to form an inductor, it is also possible to form an inductor built-in element in which the entire periphery of the copper wire is surrounded by a molded body of soft magnetic particles by hot molding after both the magnetic powder and the copper wire portion are put into a mold. In the above example, although the ring-shaped dust core is formed and evaluated, it is also possible to form a core having a bar magnet shape in which a copper wire is inserted into an inductor wound in a spring shape.

In the above example, although the metal particles coated with MoS₂ are granulated and put into a mold to perform hot molding, it is also possible to form a dust core by mixing the MoS₂-coated metal particles with a binder and an organic solvent, then molding the mixture into a sheet, punching and laminating the mixture, and then compression-molding the mixture in a heated environment.

### Examples 7 to 10

A dust core was produced by the same method as in Example 6 using the soft magnetic metal powder subjected to the coating treatment produced in Examples 2 to 5. The target thickness of the MoS₂ film, the molding density (100−porosity) of the dust core, the space factor of the soft magnetic metal particle, the volume resistivity, the initial permeability of the dust core at 100 kHz and 100 MHz, and the loss when a magnetic field of 0.1 T and 50 kHz is applied in each Example are shown in Table 3.

### Comparative Example 2

A dust core was produced by the same method as in Example 6 using the powder used in Comparative Example 1. The target thickness of the MoS₂ film, the molding density (100−porosity) of the dust core, the space factor of the soft magnetic metal particle, the volume resistivity, the initial permeability of the dust core at 100 kHz and 100 MHz, and the loss when a magnetic field of 0.1 T and 50 kHz is applied are shown in Table 3.

As shown in Table 3, the molding density of the dust core tends to be larger in Examples 9 and 10 in which the target thickness of the MoS₂ film is larger, whereas the space factor of the soft magnetic metal particle tends to be larger in Examples 6 to 8 in which the target thickness is smaller. The reason for this is that the molding density is easily improved in the example in which the MoS₂ film is thicker because of better lubricity, but the space factor of the soft magnetic metal particle is decreased because the amount of MoS₂ occupying the inside of the magnetic core is also relatively increased. In the example in which the MoS₂ film is thin, the molding density is hardly improved, but the space factor of the soft magnetic metal particle increases since the amount of MoS₂ is small. As for the volume resistivity, as in Examples 1 to 5 described for the powder, a high volume resistivity of several tens to several 1000 Ω·cm can be realized when a soft magnetic metal powder coated with MoS₂ is used in a target amount of only 6 nm. Due to this effect, the loss can also be reduced to about 200 kW/m³. On the other hand, in the dust core (Comparative Example 2) using a soft magnetic metal powder not coated with MoS₂, a short circuit occurred, and electric resistance could not be measured. The loss was also significantly increased to 1689 kW/m³.

TABLE 3

| | Target | Average thickness | Molding | Space factor | | | | Loss when |
|---|---|---|---|---|---|---|---|---|
| | thickness | (actual | density | of soft | | | | magnetic field |
| | of MoS₂ | measurement) of | of dust | magnetic | Volume | Initial | Initial | of 0.1 T and 50 |
| | film | interface layer | core | metal particle | resistivity | permeability | permeability | kHz is applied |
| | (nm) | (nm) | (%) | (%) | (Ωcm) | at 100 kHz | at 100 MHz | (kW/m³) |
| Example 6 | 25 | 83 | 94.60% | 90.20% | 975 | 62 | 60 | 144.3 |
| Example 7 | 6 | Unmeasurable | 93.40% | 90.90% | 5048 | 80 | 79 | 155.5 |
| Example 8 | 13 | Unmeasurable | 94.50% | 91.30% | 1268 | 71 | 69 | 154.7 |
| Example 9 | 50 | 139 | 96.60% | 89.70% | 635 | 59 | 59 | 196.4 |
| Example 10 | 100 | 256 | 95.30% | 84.00% | 30 | 46 | 40 | 227.7 |
| Comparative | 0 | 0 | 93.60% | 91.70% | Short circuit | 101 | 2 | 1689.5 |
| Example 2 | | | | | | | | |

### Examples 11 and 12

Additives shown in Table 4 were mixed with the soft magnetic metal powder in an amount to have a target thickness of 50 nm and was treated by the same method as in Example 1. Talc was manufactured by Sigma-Aldrich (average particle size: 10 μm) and added in an amount of 2.2 wt. %. Mica was manufactured by YAMAGUCHI MICA CO., LTD. (average particle size: 5 μm) and added in an amount of 2.4 wt. %.

TABLE 4

| | | Addition amount | Powder resistivity |
|---|---|---|---|
| | | of additive | during pressurization |
| | Additive | (wt %) | at 64 MPa (Ωcm) |
| Example 11 | Talc | 2.2 | >10⁷ |
| Example 12 | Mica | 2.4 | >10⁷ |

From Table 4, it is found that, when talc and mica are added, the electric resistance of the soft magnetic metal powder subjected to the coating treatment obtained in the same manner as MoS₂ can be significantly improved.

Talc and mica, as well as pyrophyllite and kaolinite, which are not used in Examples described above, are configured by layers in which structures including a silicate (SiO₄) or the like are connected in a plane direction perpendicular to the c axis by a strong bond formed by a covalent bond or an ionic bond, and have a structure in which such layers overlap each other by a weak van der Waals bond. Therefore, similarly to MoS₂, MoS₂ can be used as a heat-resistant and insulating solid lubricant.

### Example 13

Boron nitride (BN) was mixed with the soft magnetic metal powder in an amount (1.8 wt. %) to have a target thickness of 50 nm and was treated by the same method as in Example 1. Boron nitride (BN) is manufactured by Kojundo Chemical Laboratory Co., Ltd. (average particle size: 10 μm). A dust core was produced by the same method as in Example 6 using the obtained powder. The types of additives and the losses when a magnetic field of 0.1 T and 50 kHz is applied in each Example are shown in Table 5.

### Examples 14 and 15

Dust cores were produced by the same method as in Example 6 using the powders produced in Examples 11 and 12. The types of additives and the losses when a magnetic field of 0.1 T and 50 kHz is applied in each Example are shown in Table 5.

TABLE 5

| | | Molding | Space factor | | | Loss when |
|---|---|---|---|---|---|---|
| | | density | of soft | | | magnetic field |
| | | of dust | magnetic | Initial | Initial | of 0.1 T and 50 |
| | | core | metal particle | permeability | permeability | kHz is applied |
| | Additive | (%) | (%) | at 100 kHz | at 100 MHz | (kW/m³) |
| Example 13 | BN | 91.60% | 83.70% | 84.1 | 7.6 | 426 |
| Example 14 | Talc | 93.10% | 85.10% | 63.8 | 11.2 | 234 |
| Example 15 | Mica | 89.40% | 81.70% | 45 | 6.2 | 525.7 |

As shown in Table 5, it is found that the loss of Examples 13 to 15 can be suppressed to be lower than the loss of Comparative Example 2 (a magnetic core produced without addition of a high-resistance material such as MoS₂).

What is claimed is:

1. A soft magnetic metal powder comprising:
a coated particle including a soft magnetic metal particle and a coating layer coating a surface of the soft magnetic metal particle,
wherein the coating layer contains at least one compound selected from the group consisting of molybdenum disulfide, molybdenum oxide, boron nitride, mica, talc, pyrophyllite, and kaolinite.

2. The soft magnetic metal powder according to claim 1, wherein
the coating layer has an average thickness of from 1 nm to 200 nm.

3. The soft magnetic metal powder according to claim 1, wherein
the coated particle has the coating layer as an outermost layer.

4. The soft magnetic metal powder according to claim 1, wherein
a powder resistivity during pressurization at 25° C. and 64 MPa is 1×10³ Ω·cm or more.

5. The soft magnetic metal powder according to claim 2, wherein
the coated particle has the coating layer as an outermost layer.

6. The soft magnetic metal powder according to claim 2, wherein
a powder resistivity during pressurization at 25° C. and 64 MPa is 1×10³ Ω·cm or more.

7. The soft magnetic metal powder according to claim 3, wherein
a powder resistivity during pressurization at 25° C. and 64 MPa is 1×10³ Ω·cm or more.

8. A dust core comprising:
soft magnetic metal particles; and
an interface layer present at an interface between the soft magnetic metal particles,
wherein the interface layer contains at least one compound selected from the group consisting of molybdenum disulfide, molybdenum oxide, boron nitride, mica, talc, pyrophyllite, and kaolinite, and
a molding density is 85% or more.

9. The dust core according to claim 8, wherein
the molding density is from 89.40% to 96.60%.

10. The dust core according to claim 8, wherein
a volume resistivity is 20 Ω·cm or more.

11. The dust core according to claim 8, wherein
the interface layer has an average thickness of from 1 nm to 300 nm.

12. The dust core according to claim 8, further comprising:
a binding material at a grain boundary between the soft magnetic metal particles.

13. The dust core according to claim 12, wherein
the binding material is glass.

14. The dust core according to claim 13, wherein
the glass of the binding material contains at least one of bismuth, boron, vanadium, tin, and zinc.

15. The dust core according to claim 12, wherein
the interface layer and the binding material are in direct contact with each other.

16. The dust core according to claim 8, wherein
the soft magnetic metal particle and the interface layer are in direct contact with each other.

17. The dust core according to claim 8, wherein
a loss when a magnetic field of 0.1 T and 50 kHz is applied is 1000 kW/m³ or less.

18. An inductor comprising the dust core according to claim 8.

19. The dust core according to claim 9, wherein
a volume resistivity is 20 Ω·cm or more.

20. The dust core according to claim 9, wherein
the interface layer has an average thickness of from 1 nm to 300 nm.
